(19) United States
(12) Patent Application Publication
(10) Pub. No.: US 2014/0029664 A1
(43) Pub. Date: Jan. 30, 2014

(54) FRAME-LEVEL DEPENDENT BIT ALLOCATION IN HYBRID VIDEO ENCODING

(71) Applicant: THE HONG KONG UNIVERSITY OF SCIENCE AND TECHNOLOGY, Kowloon (HK)

(72) Inventors: Oscar Chi Lim AU, Clear Water Bay (HK); Chao PANG, Clear Water Bay (HK); Jingjing DAI, Clear Water Bay (HK); Feng ZOU, Clear Water Bay (HK)

(73) Assignee: THE HONG KONG UNIVERSITY OF SCIENCE AND TECHNOLOGY, Kowloon (HK)

(21) Appl. No.: 13/754,835

(22) Filed: Jan. 30, 2013

Related U.S. Application Data
(60) Provisional application No. 61/741,736, filed on Jul. 27, 2012.

(51) Int. Cl. H04N 7/26

(52) U.S. Cl. CPC H04N 19/00096
USPC 375/240.03

(57) ABSTRACT

Frame-level dependent bit allocation for hybrid video coding is presented to address issues relating to computational complexity of multi-pass coding of video data. An interframe dependency (IFDM) approach is presented which enables a quantitative measure of the coding dependency between the current frame and its reference frame. Based on the IFDM, buffer-constrained frame-level dependent bit allocation is determined (IFDM-DBA). Successive convex approximation techniques are utilized to convert an original optimization into a series of convex optimization problems.

### RELATED APPLICATIONS

This application claims priority to U.S. Provisional Patent Application No. 61/741,736, filed on Jul. 27, 2012, entitled “AN ANALYTIC FRAMEWORK FOR FRAME-LEVEL DEPENDENT BIT ALLOCATION IN HYBRID VIDEO ENCODING”, the entirety of which is incorporated herein by reference.

### TECHNICAL FIELD

The subject specification relates generally to multimedia technologies, e.g., to compression of digital video content.

### BACKGROUND

The last few decades have witnessed an explosion in the volume and availability of multimedia technologies, particularly video data. Owing to the huge size of raw video data, digital video compression is a technique enabling efficient interchange and distribution of visual information. Conventional video compression algorithms are typically based on hybrid video coding structure combining in-loop temporal motion estimation/compensation with decorrelating transform in pixel domain. Most of the existing video coding standards, such as MPEG-1/2/4 and H.261/263/264, conform to this structure.

In many video coding applications, because of storage capacity and transmission bandwidth constraints, rate control (RC) is often indispensable in order to regulate the output bitstream at a given target bitrate and lead to better visual quality. RC, which pertains to the field of rate-distortion (R-D) theory, relates to determining the minimal number of bits per coding unit, as measured by rate R that enable a signal to be received without exceeding a given distortion D. As shown in FIG. 1, typically, a RC module 100 comprises two components, a bit allocation component 110 and a quantization parameter selection component 120 to perform selection of at least one quantization parameter (QP) 130, where the QP facilitates reducing an original data volume to a reduced volume while having minimal impact on the final quality of the data (e.g., after decoding). The goal of bit allocation is to effectively allocate the total coding bits available for a plurality of received coding units 140 (e.g. a plurality of macroblocks (MB), slices, frames, etc., comprising an image) such that the total distortion of an image is minimized in comparison with a previous and/or subsequent image. With QP selection, the quantization parameter(s) 130 need to be determined to facilitate encoding a received coding unit 140 in accordance with a target number of bits (either absolute or approximate) as assigned by the bit allocation component 110. In response to achieving such requirements pertaining to accurate bitrate adaption, many rate-quantization (R-Q) models such as the quadratic model, the ρ-domain model, and the statistical model have been developed.

An optimal frame-level bit allocation strategy can be obtained by solution of the following, per Equation 1:

$$\begin{matrix}min \\ {R}_{i}\end{matrix} \overline{D} ( {R}_{1} , {R}_{2} , … , {R}_{N} ) i = 1 , … , N \\ s . t . \\ {\sum }_{i = 1}^{N} {R}_{i} \leq R , \qquad ( Equation 1 )$$

where R is the total available bits for N frames, Rᵢ is the number of bits allocated to the i^{th} frame and Dᵢ is the corresponding compression distortion, being measured by the mean squared error (MSE) between the original signal and the corresponding reconstructed signal. D̅ is the average distortion of the N frames, and s and t are slack variables.

Conventional frame-level bit allocation methods can be classified into two categories: independent bit allocation (IBA) methods and dependent bit allocation (DBA) methods. In IBA methods, the influence of the current frame on a future frame is neglected and the rate-distortion (R-D) functions of the frames to be encoded are assumed to be independent. Consequently, D̅ in Equation 1 can be separately represented for each frame and the optimization problem of Equation 1 can be simplified, per Equation 2:

$$\begin{matrix}min \\ {R}_{i}\end{matrix} {\sum }_{i = 1}^{N} {D}_{i} ( {R}_{i} ) i = 1 , … , N \\ s . t . \\ {\sum }_{i = 1}^{N} {R}_{i} \leq R , \qquad ( Equation 2 )$$

With the simplification of Equation 2, an optimal solution can be derived using conventional optimization methods such as Lagrangian optimization. Bit allocation methods utilized in conventional RC algorithms, both one-pass and two-pass, are IBA methods. However, the IBA methods relax the problem presented in Equation 1 by neglecting the coding dependency between neighboring frames, and thus are only able to provide sub-optimal bit allocation solutions. Because of the problem relaxation, the coding performance gap between IBA methods and DBA methods can be quite large.

In comparison with IBA methods, DBA methods take interframe coding dependency into consideration. In one approach, assuming that all the coding units (e.g., macroblocks, slices, frames, etc.) in each frame are encoded with the same QP, a search tree can be established and the problem in Equation 1 can be optimally solved through searching all the possible combinations of QP, R and/or D for the frames to be encoded. However, the computational complexity of such a brute-force search method increases exponentially with the total number of frames to be coded. Based on the observation that the R-D functions for the predicted frame are usually monotonic (i.e., preserve a given order) in the quality of the reconstructed reference frame, the complexity of derivation can be greatly reduced by pruning the search tree, where the computational complexity is dominated by generating the necessary R-D operation points. To address such an issue, faster approaches have been derived which utilize fewer R-D operation points for a given R-D curve reconstruction. For example, a steepest descent algorithm provides an approximation in achieving the optimal DBA solution. Although such implementations have greatly reduced the computational complexity compared with the brute-force search method, the computational burden is still not amenable to many applications owing to the involved multi-pass coding. To avoid multipass coding, a model-based DBA method exists where the interframe dependency is quantitatively measured by the percentage of skipped MBs in one frame and, based thereon, an optimal DBA strategy is obtained analytically. However, such a method can only handle static sequences and the skipped MB percentage cannot be accurately estimated before the real encoding. Further, in hybrid video coding, a coding dependency between non-skipped MBs and their reference MBs also exists, which also cannot be detected using such an interframe dependency measure.

### BRIEF DESCRIPTION OF THE DRAWINGS

Various non-limiting embodiments are further described with reference to the accompanying drawings in which:

FIG. 1 is a block diagram illustrating a rate control system.

FIG. 2 is a block diagram illustrating exemplary, non-limiting embodiments for bit allocation for a plurality of frames.

FIG. 3 is a diagram illustrating fitting performance by an IFDM in accordance with exemplary, non-limiting embodiments for bit allocation for a plurality of frames.

FIG. 4 is a diagram illustrating fitting performance by an IFDM in accordance with exemplary, non-limiting embodiments for bit allocation for a plurality of frames.

FIG. 5 is a diagram illustrating fitting performance by an IFDM in accordance with exemplary, non-limiting embodiments for bit allocation for a plurality of frames.

FIG. 6 is a diagram illustrating fitting performance by an IFDM in accordance with exemplary, non-limiting embodiments for bit allocation for a plurality of frames.

FIG. 7 is a diagram illustrating fitting performance by a R-D function in accordance with exemplary, non-limiting embodiments for bit allocation for a plurality of frames.

FIG. 8 is a diagram illustrating fitting performance by a R-D function in accordance with exemplary, non-limiting embodiments for bit allocation for a plurality of frames.

FIG. 9 is a diagram illustrating fitting performance by a R-D function in accordance with exemplary, non-limiting embodiments for bit allocation for a plurality of frames.

FIG. 10 is a diagram illustrating fitting performance by a R-D function in accordance with exemplary, non-limiting embodiments for bit allocation for a plurality of frames.

FIG. 11 is a block diagram illustrating exemplary, non-limiting embodiments for bit allocation for a plurality of frames.

FIG. 12 is a diagram illustrating successive convex approximation in accordance with exemplary, non-limiting embodiments for bit allocation for a plurality of frames.

FIG. 13 is a flow diagram illustrating an exemplary, non-limiting embodiment for bit allocation for a plurality of frames.

FIG. 14 is a flow diagram illustrating an exemplary, non-limiting embodiment for bit allocation for a plurality of frames.

FIG. 15 is a diagram illustrating actual and estimate variance in accordance with exemplary, non-limiting embodiments for bit allocation for a plurality of frames.

FIG. 16 is a diagram illustrating actual and estimate variance in accordance with exemplary, non-limiting embodiments for bit allocation for a plurality of frames.

FIG. 17 is a diagram illustrating actual and estimate variance in accordance with exemplary, non-limiting embodiments for bit allocation for a plurality of frames.

FIG. 18 is a diagram illustrating peak signal-to-noise ratios (PSNR) in accordance with exemplary, non-limiting embodiments for bit allocation for a plurality of frames.

FIG. 19 is a diagram illustrating PSNR in accordance with exemplary, non-limiting embodiments for bit allocation for a plurality of frames.

FIG. 20 is a diagram illustrating actual and estimate variance in accordance with exemplary, non-limiting embodiments for bit allocation for a plurality of frames.

FIG. 21 is a diagram illustrating actual and estimate variance in accordance with exemplary, non-limiting embodiments for bit allocation for a plurality of frames.

FIG. 22 is a diagram illustrating actual and estimate variance in accordance with exemplary, non-limiting embodiments for bit allocation for a plurality of frames.

FIG. 23 is an example networking environment.

FIG. 24 is an example computing environment.

### DETAILED DESCRIPTION

The various embodiments are now described with reference to the drawings, wherein like reference numerals are used to refer to like elements throughout. In the following description, for purposes of explanation, numerous specific details are set forth in order to provide a thorough understanding of the various embodiments. It can be evident, however, that the various embodiments can be practiced without these specific details. In other instances, well-known structures and devices are shown in block diagram form in order to facilitate describing the various embodiments.

As previously described, a number of approaches exist as a result of various attempts to maximize a level of compression of data to facilitate improved storage and transmission of digital format video while minimizing distortion. To overcome the limitations of existing DBA methods, e.g., limited to handling static sequences, poor estimation of a skipped MB percentage, inability to detect coding dependency between non-skipped MBs and their reference MBs, etc., an approach of frame-level dependent bit allocation (IFDM-DBA) is presented in the various exemplary, non-limiting embodiments herein. IFDM-DBA can efficiently allocate available bits to frames based on novel coding dependency. To facilitate understanding of the various exemplary, non-limiting embodiments, a dependency model is initially presented based on a predictive approach for hybrid video coding, wherein the dependency model can enable quantitative measurement of coding dependency for both skipped MBs and non-skipped MBs. Further, an exemplary, non-limiting embodiment of utilizing a buffer-constrained DBA is presented utilizing successive convex approximation to convert an initial optimization problem into a series of convex optimization problems of which optimal solutions can be efficiently obtained. In an exemplary, non-limiting embodiment, the buffer-constrained DBA approach can be utilized in conjunction with framewise R-D functions for intra-coded and inter-coded frames.

### An Interframe Dependency Model (IFDM)

In a generic hybrid video encoder, such as MPEG-1/2/4 and H.261/263/264 encoder, differential pulse code modulation (DPCM) in the form of motion-compensated coding is common. At the encoder side, an input frame can be divided into non-overlapped blocks (e.g., macroblocks) and encoded block by block. For each block, motion estimation (ME) is utilized to exploit the temporal redundancy between a current frame and its reference frame, where the reference frame is usually selected from a reconstruction of previous frames in order to avoid the mismatch between the encoder and decoder. During ME, the best-matched block, in terms of minimum sum of absolute differences (SAD) or sum of absolute transformed differences (SATD), is chosen to be the prediction block. A residue block is further calculated by subtracting the prediction block from the original block (e.g., a block comprising the current frame). Finally, the residue block is transformed using discrete cosine transform (DCT), wherein transform coefficients are quantized and entropy coded.

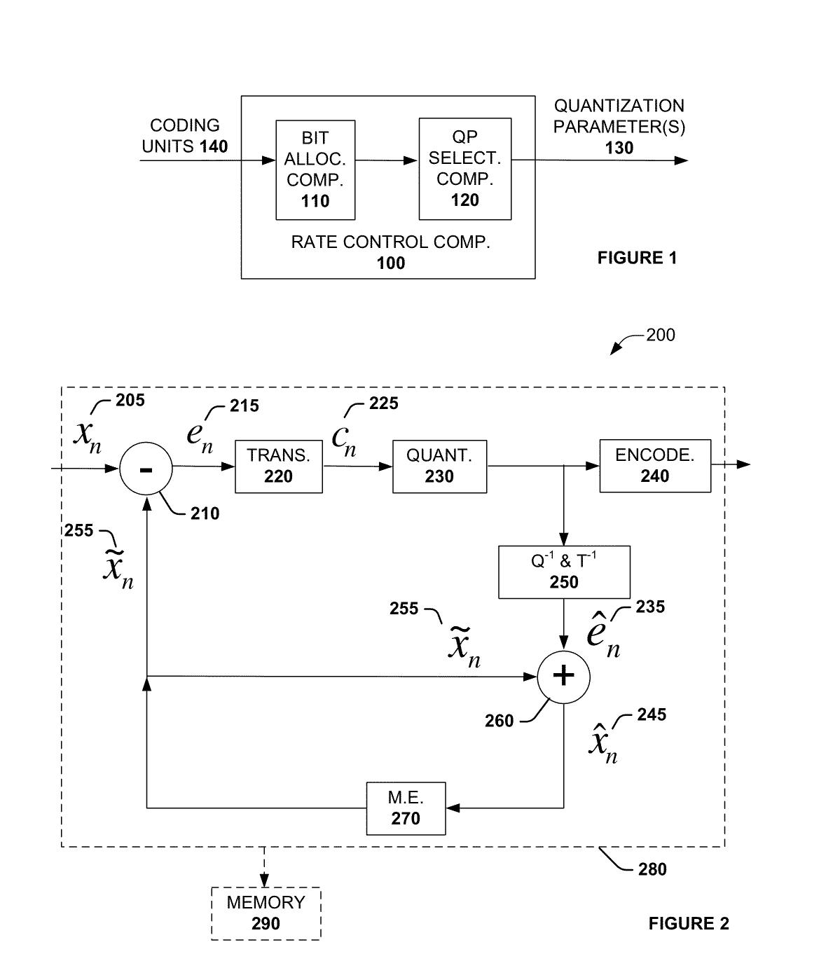

FIG. 2 illustrates an exemplary, non-limiting embodiment of system 200 comprising a hybrid video encoder. Effectively, FIG. 2 presents a representation of coding dependency between neighboring frames in hybrid video encoding. System 200 comprises a plurality of components which act on an input signal to facilitate transformation (e.g., by transformation component 220), quantization (e.g., by quantization component 230), signal difference determination (e.g., by difference component 210), quantization and transformation determination of a previous signal (e.g., with Q⁻¹ & T⁻¹ component 250), residue and prediction combination (e.g., by addition component 260), and motion estimation between frames (e.g., by motion estimation component 270). The various components comprising FIG. 2 (e.g., 210, 220, 230, 240, 250, 260, and 270) can be incorporated/operating on a processing component 280, where processing component 280 can be associated with a memory component 290 which can be utilized to store data, application code, algorithms, etc. For example, memory component 290 can be utilized as a buffer memory during execution of the various embodiments presented herein. As illustrated in FIG. 2, a signal can be forwarded, e.g., from the quantization component 230, to an encoder 240 for subsequent generation of an encoded signal to be transmitted (e.g., across a network) as well as being fed back into the system (e.g., into Q⁻¹ & T⁻¹ component 250) to facilitate determination of bit allocation, etc., for a subsequent input signal. As shown in FIG. 2, xₙ (205) is the input signal of the n^{th} frame, \tilde{x}ₙ (255) is the prediction signal of \tilde{x}ₙ (205), and Cₙ (225) is the DCT coefficient of the n^{th} frame. The residue signal eₙ (215) can be generated based on the difference between the input signal 205 and the prediction signal 255, per Equation 3:

eₙ=xₙ=\tilde{x}ₙ (Equation 3)

where, in general, the reference frame of the n^{th} frame can be assumed to be the reconstructed frame of the immediately preceding frame. Hence, Equation 3 can be resolved to become Equation 4:

\tilde{x}ₙ=\hat{x}ₙ₋₁ (Equation 4)

where \hat{x}ₙ₋₁ is the reconstructed signal of the n−1^{th} frame.

Combining Equations 3 and 4 yields Equation 5:

$$\begin{matrix}{e}_{n} = {x}_{n} - {\hat{x}}_{n - 1} \\ = \underbrace{( {x}_{n} - {x}_{n - 1} )}_{{z}_{n}} + \underbrace{( {x}_{n - 1} - {\hat{x}}_{n - 1} )}_{{q}_{n - 1}}\end{matrix} \qquad ( Equation 5 )$$

where zₙ is the prediction error between the input signal and the original signal of the n−1^{th} frame for prediction, and qₙ₋₁ is the quantization error of the n−1^{th} frame.

In an exemplary, non-limiting embodiment, the expected values of eₙ, cₙ, zₙ, and qₙ₋₁ can be assumed to be zero. Based on such assumption, the variance of eₙ denoted by σₑ_{ₙ}², can be derived, per Equation 6:

$$\begin{matrix}{σ}_{{e}_{n}}^{2} = 𝔼 ( {e}_{n}^{2} ) \\ = 𝔼 ( {( {q}_{n - 1} + {z}_{n} )}^{2} ) \\ = 𝔼 ( {q}_{n - 1}^{2} ) + 𝔼 ( {z}_{n}^{2} ) \\ = {D}_{n - 1} + {σ}_{{z}_{n}}^{2}\end{matrix} \qquad ( Equation 6 )$$

where Dₙ₋₁ is the compression distortion, measured by MSE, of the n−1^{th} frame, and σ_{z}_{ₙ}² is the variance of zₙ of the n^{th} frame. It is to be noted that Equation 3 holds based on an assumption that zₙ and qₙ₋₁ are uncorrelated.

Further, as DCT can be a unitary transform, the variance of the DCT coefficients denoted by σ_{c}_{ₙ}² is, per Equation 7:

σ_{c}_{ₙ}²=σₑ_{ₙ}²=Dₙ₋₁+σ_{z}_{ₙ}² (Equation 7)

However, it is to be appreciated that Equation 7 requires slight modification to be more accurate when being used within a specific video coding standard. This can be due to the compression technique(s) utilized and/or dedicated to a specific video coding standard, which make it difficult to estimate Dₙ₋₁ and σ_{z}_{ₙ}² exactly before the real encoding. For example, in H.264/AVC, rate-distortion optimization (RDO) techniques are often employed at the encoder (e.g., encoder 240) to achieve superior performance. Consequently, this can potentially influence the statistics of DCT coefficients. RDO can be used to select the optimal encoding parameters (i.e. number of block partitions, intraprediction modes, motion vectors, etc.) for each MB in a R-D optimized sense. During RDO, the predefined R-D cost corresponding to each possible encoding parameter can be calculated, and the encoding parameter leading to the minimal R-D cost can be selected as the final encoding parameter. Typically, RDO contains R-D optimized mode decision and R-D optimized ME. The corresponding R-D costs, RDCost_{mode} and RDCost_{ME}, for mode decision and ME, are defined as, per Equation 8:

RDCost_{mode}=SSD+λ_{mode}·Rate

RDCost_{ME}=SSD+λ_{ME}·Rate (Equation 8)

where λ_{mode} and λ_{ME} are Lagrange multipliers which can be obtained, per Equations 9 and 10:

$$\begin{matrix}{λ}_{mode} = c \cdot {Q}^{2} , \\ c = \{ \begin{matrix}0.68 , if no . of B frames > 0 \\ 0.85 , otherwise\end{matrix} & ( Equation 9 ) \\ {λ}_{ME} = \sqrt{{λ}_{mode}} & ( Equation 10 )\end{matrix}$$

where Q is the quantization stepsize.

Equations 8, 9 and 10 imply that, when a Q of large magnitude is employed which implies a larger Lagrange multiplier value, the encoder favors a mode generating less bits and pays less attention to the distortion this mode might produce. In such a case, the variance of the residue signals σₙ² tends to be larger. However, if the current coding unit is quantized with a Q of smaller magnitude, a mode with less distortion can be chosen with a corresponding smaller value for σₙ².

Because of the influence of the RDO on the statistics of DCT coefficients, one more item, Q, is added in Equation 7. Moreover, α, σ and γ are introduced to improve the accuracy of Equation 7. Hence, Equation 7 becomes, per Equation 11:

σₙ²=α·Dₙ₋₁+β·+γ·Qₙ (Equation 11)

Where σₙ² is the variance of DCT coefficients of the n^{th} frame, and \tilde{σ}ₙ² is an estimate of σ_{z}_{ₙ}² before the real encoding. Qₙ is the quantization stepsize (Q) for the n^{th} frame. α, σ and γ are positive parameters. Equation 11 indicates the influence of the reference frame on the R-D characteristics of the current frame, and the various parameter relationships denoted therein can be considered an interframe dependency model (IFDM).

To apply the IFDM, an estimation of \tilde{σ}ₙ² in Equation 11 is required. By performing ME of an original video sequence, \tilde{σ}ₙ² is estimated to be the variance of the residue. It is to be noted that the ME results derived from utilizing Equation 11 are usually different to those ME results obtained during the real encoding of a current frame. Thus, \tilde{σ}ₙ² can be viewed as an estimate of σ_{z}_{ₙ}².

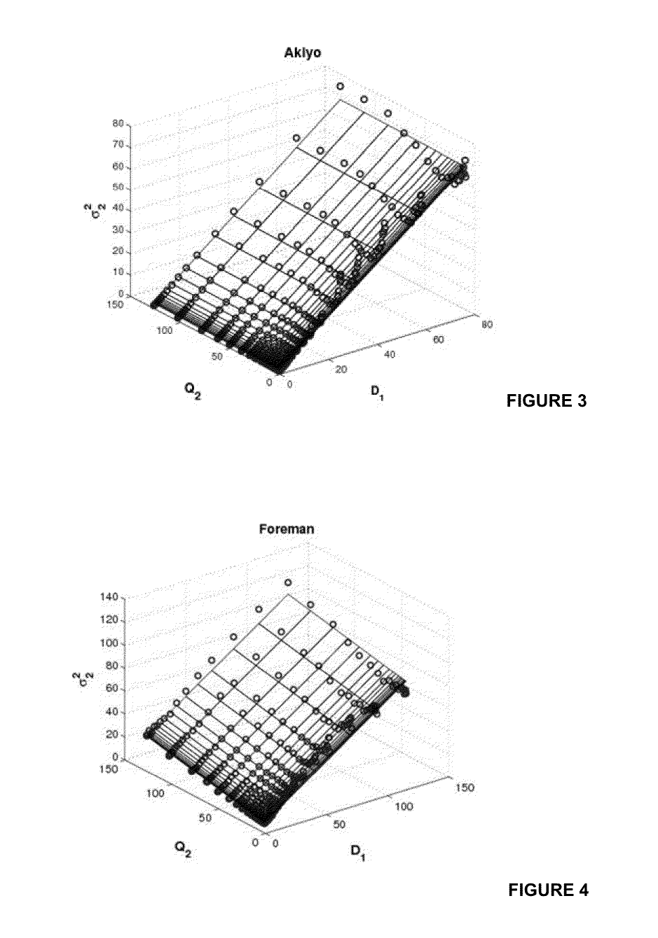

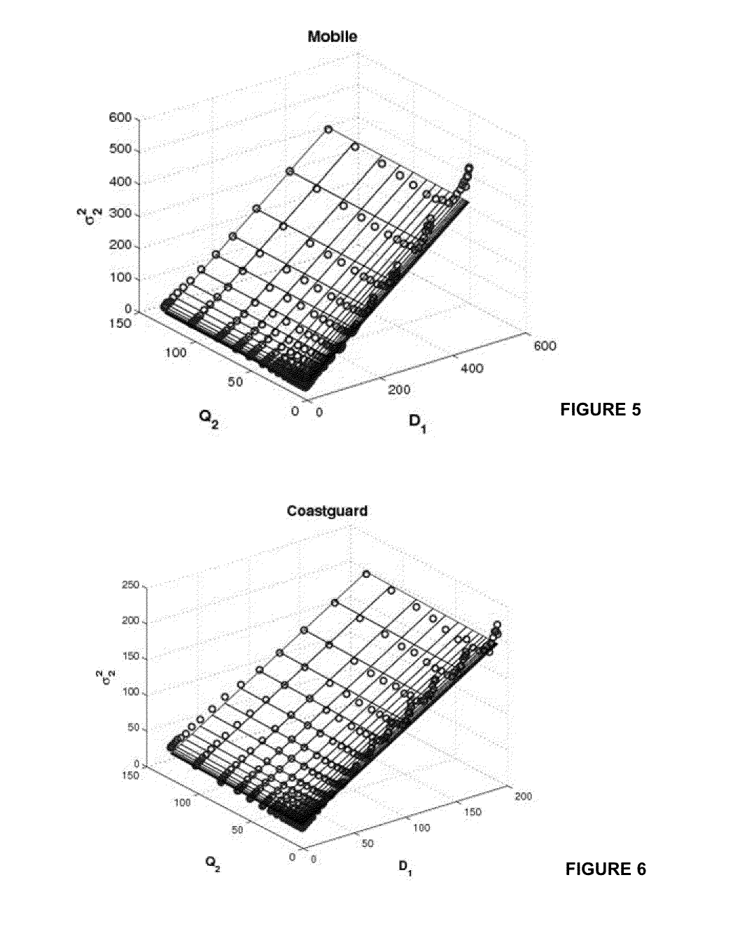

The accuracy of the IFDM of Equation 11 is presented in FIGS. 3-6 with the fitting performances of several video test sequences, Akiyo, Foreman, Mobile, and Coastguard depicted. In FIGS. 3-6, Dₙ₋₁ is plotted on the x-axis and σₙ² is plotted on the y-axis. For each video sequence, two neighboring frames (N=2) are randomly chosen and encoded, where QP₁ and QP₂ are the QPs used to encode the two neighboring frames. In the experiments, QP₁ and QP₂ are selected to be every two QP values ranging from 10 to 46, hence, there are a total of 361 possibilities of the QP pair (QP₁, QP₂). During each encoding process, the following coding parameters were recorded: the DCT coefficient variance of the second frame σ₂², the Q used for the second frame Q₂ and the compression distortion of the first frame D₁. As shown in FIGS. 3-6, there is good correlation between the IFDM value(s) generated by Equation 11 and the original data comprising each of the video test sequences.

In addition, Table 1 shows the estimation accuracy in terms of the [symbol] ² values of the previously described IFDM for some typical video sequences. [symbol] ² is a metric used to quantitatively measure the degree of data variation from a given model, and is defined as

$${ℝ}^{2} = 1 - \frac{{\sum }_{i}^{ } {( {X}_{i} - {\hat{X}}_{i} )}^{2}}{{\sum }_{i}^{ } {( {X}_{i} - {\overline{X}}_{i} )}^{2}} \qquad ( Equation 12 )$$

where Xᵢ and \hat{X}ᵢ are the real and the estimated values of one data point i, and X̅ is the mean of all the data points. The closer the value of [symbol] ² is to 1, the more accurate the model is. Further, the accuracy of the IFDM described herein is compared with a standard model. From Table 1, it can be seen that the [symbol] ² values of the IFDM described herein are higher than the [symbol] ² values of the standard model, implying that the IFDM described herein has a better estimation accuracy in estimating σₙ².

TABLE 1
Comparison of R² values of the IFDM and a standard model

| | [symbol] ² using | |
|---|---|---|
| | the standard | [symbol] ² using |
| Sequence | model | the IFDM |
| Akiyo | 0.946 | 0.976 |
| Coastguard | 0.939 | 0.974 |
| Foreman | 0.796 | 0.973 |
| Mobile | 0.931 | 0.975 |
| City | 0.932 | 0.966 |
| Shuttlestart | 0.839 | 0.972 |
| Cactus | 0.846 | 0.982 |
| Traffic | 0.946 | 0.978 |

### IFDM-Based Frame-Level Dependent Bit Allocation (IFDM-DBA)

Exemplary, non-limiting embodiments relating to an IFDM-based frame-level dependent bit allocation method (IFDM-DBA) are further presented. To facilitate understanding of the various embodiments relating to the IFDM-DBA algorithm, framewise R-D functions and buffer constraints are introduced as applicable to the IFDM-BDA.

A. Framewise R-D Functions

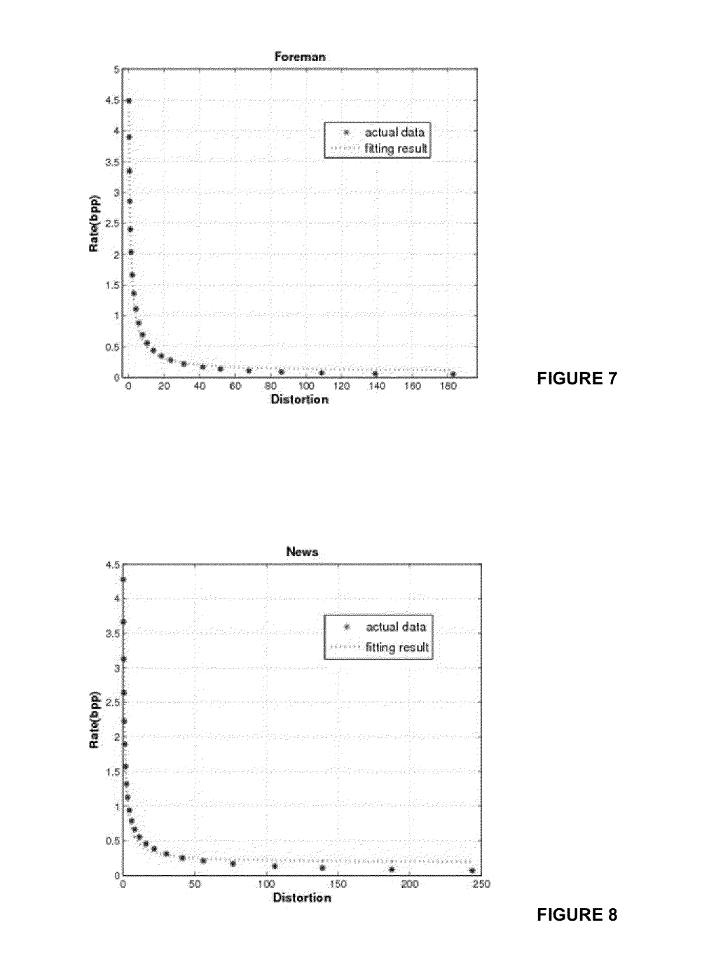

For intra-coded frames, in order to accommodate the variety of content(s) in a video sequence(s), a frame complexity guided R-D model can be employed, per Equation 13:

$$R ( D ) = G \cdot ( \frac{{a}_{0}}{D + {b}_{0}} + {c}_{0} ) \qquad ( Equation 13 )$$

where G is the average gradient of a frame, and a₀, b₀, and c₀ are model parameters. The fitting performance of the R-D function in Equation 13 for intra-coded frames is shown in FIGS. 7 and 8. FIGS. 7 and 8 comprise Distortion on the x-axis and Rate (bpp) on the y-axis, with ‘actual data’ depicted along with a ‘fitting results’.

As for inter-coded frames, since the DCT coefficients are assumed to be of zero-meaned Laplacian distribution, Equation 14 is derived:

$$R ( D ) = {a}_{1} \cdot log \frac{{σ}^{2}}{D} \\ where \\ {σ}^{2} > D \qquad ( Equation 14 )$$

where a₁ is a model parameter and σ² is the variance of the DCT coefficients. In experiments conducted in accord with the various exemplary, non-limiting embodiments presented herein, it is possible that the R-D function fails to model the header bits (e.g. at a macroblock level, a slice level, etc.) which are required to be transmitted even when the all the DCT coefficients are quantized to zero. Therefore, Equation 14 can be slightly modified by adding an offset b₁ to compensate for the failure to model the header bits, as shown in Equation 15:

$$R ( D ) = {a}_{1} \cdot log \frac{{σ}^{2}}{D} + {b}_{1} \\ where \\ {σ}^{2} > D \qquad ( Equation 15 )$$

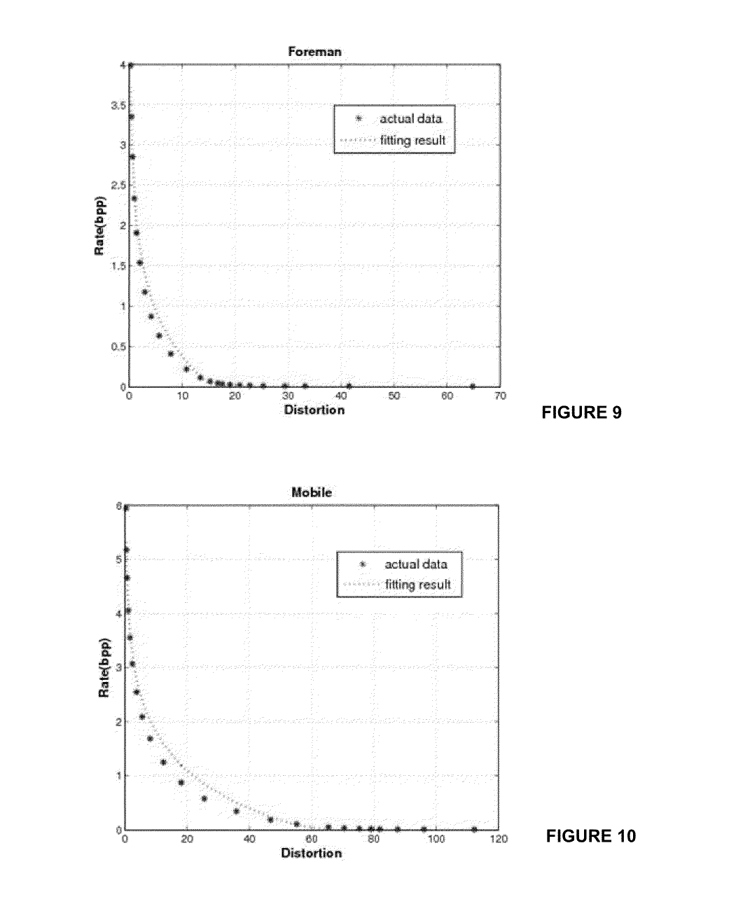

The fitting performance of the R-D function of Equation 15 for interceded frames is presented in FIGS. 9 and 10. In FIGS. 9 and 10 Distortion is plotted on the x-axis and Rate (bpp) on the y-axis, with ‘actual data’ depicted along with a ‘fitting results’.

In another exemplary, non-limiting embodiment, Equation 15 can also be used as the R-D function for intra-coded frames. Selection of the R-D function in Equation 14 for intra-coded frames can be based, in part, on either of the following two reasons: first, the variance of DCT coefficients of the intra-coded frames is difficult to estimate prior to the real encoding, and second, Equation 14 has a higher accuracy than Equation 15 regarding the accuracy of fitting performance.

To make a quantitative measure, the [symbol] ² values of the R-D models presented herein for some typical video sequences are summarized in Table 2 and 3. As shown in the tables, the [symbol] ² values are very close to 1, which implies a superior fitting performance of the R-D models for both intra-coded and inter-coded frames.

TABLE 2
R² values of the R-D functions for intra-frames

| | [symbol] ² from |
|---|---|
| Sequence | Equation 13 |
| Carphone | 0.995 |
| News | 0.990 |
| Crew | 0.993 |
| Bigships | 0.993 |
| Silent | 0.997 |
| Foreman | 0.999 |
| Shuttlestart | 0.995 |
| City | 0.995 |

TABLE 3
R² values of different R-D functions for inter-frames

| | [symbol] ² from | [symbol] ² from |
|---|---|---|
| Sequence | Equation 14 | Equation 15 |
| akiyo | 0.923 | 0.950 |
| foreman | 0.943 | 0.979 |
| mobile | 0.959 | 0.988 |
| paris | 0.913 | 0.945 |
| crew | 0.910 | 0.963 |
| shuttlestart | 0.964 | 0.987 |
| bigships | 0.947 | 0.986 |
| city | 0.978 | 0.993 |

B. Buffer Constraints

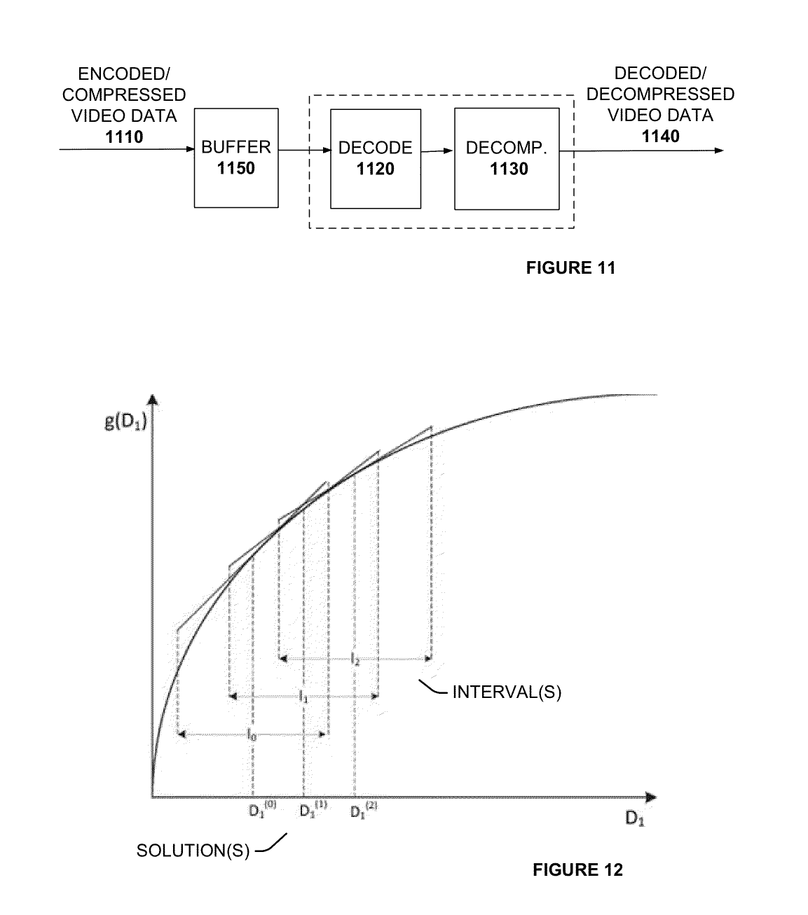

FIG. 11 illustrates an exemplary, non-limiting embodiment for decoding and/or decompressing video content. An encoded/compressed video data 1110 transmission can be received at a decoder component 1120 and/or a decompression component 1130 which can be utilized to drain the compressed data 1110, decode the data 1110, and utilize the generated decoded/decompressed video data 1140 to facilitate presentation of an image (e.g., comprising one or more frames, macroblocks, etc.) to an end user(s). A decoder buffer 1150 is often utilized to receive the video data 1110, where a portion of the video data 1110 can be temporarily stored in decoder buffer 1150 while another portion is being processed by decoder component 1120 and/or decompression component 1130. Per the following, to facilitate an efficient IFDM-DBA, account is to be taken of the size of the required/available decoder buffer 1150. In setting Rᵢ to be the allocated bits to the i^{th} frame and T₀ be the initial decoding delay (in frames) of the decoder, the decoder buffer occupancy denoted by Bₙ, can be calculated from the difference between the output and input bits of the buffer, per Equation 16:

$${B}_{n} = \{ \begin{matrix}n \cdot \overline{R} - {\sum }_{i = 1}^{n - {T}_{0}} {R}_{i} & if n \geq {T}_{0} \\ {\sum }_{i = 1}^{n} {R}_{i} & otherwise\end{matrix} \qquad ( Equation 16 )$$

where R̅ is the average bits allocated to each frame, which can be determined per Equation 17:

$$\overline{R} = \frac{{B}_{R}}{{F}_{R}} \qquad ( Equation 17 )$$

where B_{R} is the target bitrate and F_{R} is the target framerate.

In bit allocation, an important requirement is to avoid buffer underflow or buffer overflow occurring at the decoder component 1120. Effectively, the buffer occupancy of buffer component 1150 should be less than the buffer capacity, per Equation 18:

0≦Bₙ≦B (Equation 18)

where B is the buffer capacity. The constraints in Equation 17 are the buffer constraints which need to be conformed with during a bit allocation operation.

C. Frame-Level Dependent Bit Allocation (IFDM-DBA)

By utilizing the previously described IFDM, framewise R-D model and buffer constraint(s), various exemplary, non-limiting embodiments for buffer-constrained frame-level dependent bit allocation (IFDM-DBA) are presented.

Assuming there are N frames in each group of pictures (GOP), with the first frame encoded as intra-coded frame and all the following N−1 frames encoded as inter-coded frames, then R=[R₁, R₂, . . . , R_{N}] for the bit allocation strategy to the N frames and D=[D₁, D₂, . . . , D_{N}] is the corresponding compression distortion. In the following embodiments determination of a frame-level bit allocation strategy R is performed under a predefined total bit budget such that the total distortion of the N frames is minimized, while conforming to the buffer constraints. Mathematically, the buffer-constrained frame-level dependent bit allocation problem can be formulated as, per Equation 19:

$${min}_{R , D} {\sum }_{i = 1}^{N} {D}_{i} \\ s . t . \\ {\sum }_{i = 1}^{N} {R}_{i} \leq {R}_{GOP} \\ {R}_{1} = G \cdot ( \frac{{a}_{0}}{D + {b}_{0}} + {c}_{0} ) \\ {R}_{j} = {a}_{1} \cdot log \frac{{σ}_{j}^{2}}{{D}_{j}} + {b}_{1} j = 2 , 3 , … , N \\ {σ}_{j}^{2} = α \cdot {D}_{j - 1} + β \cdot {\overline{σ}}_{j}^{2} + γ \cdot {Q}_{j} \\ 0 \leq {B}_{i} \leq B \qquad ( Equation 19 )$$

where R_{GOP} is the total bit budget for the N frames in current GOP and R_{GOP} can be calculated as, per Equation 20:

R_{GOP}=N· R̅+Rᵣₑₘ (Equation 20)

where Rᵣₑₘ is the remaining bits from the previous GOP.

By combining the constraints in Equation 19, per that shown in Equations 21a and 21b, Equation 19 can be rewritten as Equation 21:

$${min}_{R , D} {\sum }_{i = 1}^{N} {D}_{i} \\ s . t . \\ {R}_{1} + {a}_{1} \cdot {\sum }_{j = 2}^{N} log \frac{α \cdot {D}_{j - 1} + β \cdot {\tilde{σ}}_{j}^{2} + γ \cdot {Q}_{j}}{{D}_{j}} + ( N - 1 ) \cdot {b}_{1} \leq {R}_{GOP} \\ {R}_{1} = G \cdot ( \frac{{a}_{0}}{{D}_{1} + {b}_{o}} + {c}_{0} ) \\ 0 \leq {B}_{i} \leq B \qquad ( Equation 21 a )$$

which becomes:

$${\sum }_{j = 2}^{N} log \frac{α \cdot {D}_{j - 1} + β \cdot {\tilde{σ}}_{j}^{2} + γ \cdot {Q}_{j}}{{D}_{j}} = log ( α \cdot {D}_{1} + β \cdot {\tilde{σ}}_{2}^{2} + γ \cdot {Q}_{2} ) + {\sum }_{j = 2}^{N - 1} log ( α + \frac{β \cdot {\tilde{σ}}_{j + 1}^{2} + γ \cdot {Q}_{j + 1}}{{D}_{j}} ) + log \frac{1}{{D}_{N}} \qquad ( Equation 21 b )$$

and, thus by introducing slack variables s and t, Equation 19 can be considered equivalent to the optimization problem presented in Equation 22:

$${min}_{D} {\sum }_{i = 1}^{N} {D}_{i} \\ s . t \\ s + t + {a}_{1} \cdot {\sum }_{j = 2}^{N - 1} log ( α + \frac{β \cdot {\tilde{σ}}_{j + 1}^{2} + γ \cdot {Q}_{j + 1}}{{D}_{j}} ) + {a}_{1} \cdot log \frac{1}{{D}_{N}} + ( N - 1 ) \cdot {b}_{1} \leq {R}_{GOP} \\ G \cdot ( \frac{{a}_{0}}{{D}_{1} + {b}_{0}} + {c}_{0} ) \leq s \\ {a}_{1} \cdot log ( α \cdot {D}_{1} + β \cdot {\tilde{σ}}_{2}^{2} + γ \cdot {Q}_{2} ) \leq t \\ 0 \leq {B}_{i} \leq B \qquad ( Equation 22 )$$

It is to be appreciated that in order to solve the optimization problem in Equation 22, \tilde{σ}ⱼ² and Qⱼ(j=2, 3, . . . , N) need to be initially estimated. As previously discussed regarding the IFDM, ME can be performed on the corresponding original frames of a test sequence, and \tilde{σ}ⱼ² can be approximated by the variance of the residue. For Qⱼ, \tilde{σ}ⱼ² can be estimated from the average Q used in the previous GOP. While only an approximation, multi-pass coding which leads to high computational complexity can be avoided. With both \tilde{σ}ⱼ² and Qⱼ estimated, the notation can be simplified by defining, per Equation 23:

Diffⱼ=β·\tilde{σ}ⱼ²+γ·Qⱼ (Equation 23)

which is now known, and Diffⱼ positive. Thus Equation 22 becomes:

$${min}_{D} {\sum }_{i = 1}^{N} {D}_{i} \\ s . t \\ s + t + {a}_{1} \cdot {\sum }_{j = 2}^{N - 1} log ( α + \frac{{Diff}_{j + 1}}{{D}_{j}} ) + {a}_{1} \cdot log \frac{1}{{D}_{N}} + ( N - 1 ) \cdot {b}_{1} \leq {R}_{GOP} \\ G \cdot ( \frac{{a}_{0}}{{D}_{1} + {b}_{0}} + {c}_{0} ) \leq s \\ {a}_{1} \cdot \underbrace{log ( α \cdot {D}_{1} + {Diff}_{2} )}_{g ( {D}_{1} )} \leq t \\ 0 \leq {B}_{i} \leq B \qquad ( Equation 24 )$$

However, since g(D₁) is not a convex function of D₁, Equation 24 is not a convex optimization problem. Thus, it can be difficult to find the optimal solution of Equation 24 directly. With the various exemplary, non-limiting embodiments presented herein, successive convex approximation techniques can be employed to solve the optimization problem in Equation 24. To facilitate understanding of the various exemplary, non-limiting embodiments presented herein, the concept of successive convex approximation will now be briefly described. Consider the following optimization problem, per Equation 25:

$${min}_{x} {f}_{0} ( x ) \\ s . t . \\ \begin{matrix}{f}_{i} ( x ) \leq 0 & 1 \leq i \leq m , \\ {h}_{i} ( x ) = 0 & 1 \leq i \leq p ,\end{matrix} \qquad ( Equation 25 )$$

where x is the optimization variable. f₀, f₁, . . . , fₘ are convex functions while fₜ(1≦t≦m) is not convex, and h₁, h₂, . . . , hₚ are affine functions. Rather than directly solving Equation 25, which can be very difficult, Equation 25 can be solved iteratively by approximating fₜ(x) with f̅ₜ (0) which is convex. During each iteration, Equation 25 becomes a convex optimization problem of which the optimal solution can be obtained efficiently using an interior-point method. Such an iterative approximation will converge to a point satisfying a Karush-Kuhn-Tucker (KKT) condition of the original problem if the approximation of fₜ(x) meets the following 3 requirements:

fₜ(x)≦ f̅ₜ(x) for all x 1

fₜ(x₀)≦ f̅ₜ(x₀) where x₀ is the optimal solution of the approximated problem in the previous iteration, 2

∇fₜ(x₀)=∇ f̅ₜ(x₀) 3

Convergence to a single point enables solution of a convex optimization problem

In an embodiment of the IFDM-DBA algorithm presented herein, during the i^{th} iteration, g(D₁) is approximated with the affine function \tilde{g}(D₁) defining as, per Equation 26:

$$\tilde{g} ( {D}_{1} ) = \underbrace{{a}_{1} \cdot log ( α \cdot {D}_{1}^{i - 1} + {Diff}_{2} )}_{{Const}_{1}} + {\underline{α}}_{\underbrace{α \cdot {D}_{1}^{i - 1} + {Diff}_{2}}_{{Const}_{2}}} \cdot ( {D}_{1} - {D}_{1}^{i - 1} ) \qquad ( Equation 26 )$$

where Const₁ and Const₂ are 2 constants which can be determined first in each iteration, with D₁ⁱ⁻¹ being the optimal value of D₁ in the i−1^{th} iteration. To maximize the approximation accuracy, D₁ can be restricted to be in the range of [(1−ε)·D₁ⁱ⁻¹, (1−ε). D1i−1 during the i^{th} iteration. The approximation in Equation 26 meets the above 3 requirements, and hence iterative approximation of Equation 26 can converge to a point satisfying a KKT condition, per Equation 24.

With the approximation of Equation 26, the optimization problem of Equation 24 is iteratively solved. During the i^{th} iteration, Equation 24 is converted into the following optimization problem, per Equation 27:

$${min}_{R , D} {\sum }_{i = 1}^{N} {D}_{i} \\ s . t \\ s + t + {a}_{1} \cdot {\sum }_{j = 2}^{N - 1} log ( α + \frac{{Diff}_{j + 1}}{{D}_{i}} ) + {a}_{1} \cdot log \frac{1}{{D}_{N}} + ( N - 1 ) \cdot {b}_{1} \leq {R}_{GOP} \\ G \cdot ( \frac{{a}_{0}}{{D}_{1} + {b}_{0}} + {c}_{0} ) \leq s \\ {Const}_{1} + {Const}_{2} \cdot ( {D}_{1} - {D}_{1}^{i - 1} ) \leq t \\ 0 \leq {B}_{i} \leq B \\ {D}_{1} \leq ( 1 + ɛ ) {D}_{1}^{i - 1} \\ {D}_{1} \geq ( 1 - ɛ ) {D}_{1}^{i - 1} \qquad ( Equation 27 )$$

Given that the functions in the inequality constraints are convex, the objective function, being a linear function of Dᵢ is hence a convex function of Dᵢ. Therefore, the optimization problem of Equation 27 can be considered to be a convex optimization problem and an optimal solution can be obtained with an interior-point method. Any suitable application can be utilized to derive the optimal solution, for example, a software application such as MATBLAB CVX.

A geometric approach to solving Equation 24 is presented in FIG. 12, where D₁ is plotted on the x-axis and g(D₁) plotted on the y-axis. Suppose the initial point of D₁ is D₁⁽⁰⁾, then G(D₁) can be approximated using Equation 26 within the interval I₀ which is centered around D₁⁽⁰⁾, and further, Equation 24 can be converted to the convex optimization presented in Equation 27. After solving Equation 27, assuming that the optimal solution is D₁⁽¹⁾, then the new interval I₁ can be established, and g(D₁) can approximated with a new affine function of D₁ per Equation 26. Similarly, the optimal solution in I₁ can be obtained, per the denotement D₁⁽²⁾, and a new iteration can be performed. The operation(s) presented in FIG. 12 can be repeated until the total distortion converges.

Ultimately, the optimal bit allocation strategy can be (R₁^{*}, R₂^{*}, . . . , R_{N}^{*}). In practical applications, an issue is the generated bits of each frame cannot be the exact number of allocated bits because of the inaccuracy of R-Q model. Suppose the number of actual generated bits of the ith frame is Rᵢ^{actual}, to fulfill the total bit budget, the final bits allocated to the ith frame denoted by Rᵢ^{final}, is adjusted, per Equations 28 and 29:

$${\tilde{R}}_{i} = ( {R}_{GOP} - {\sum }_{j = 1}^{i - 1} {R}_{j}^{actual} ) \cdot \frac{{R}_{j}^{*}}{{\sum }_{j = n}^{N} {R}_{j}^{*}} \\ {R}_{i}^{final} = median \{ {R}_{i}^{min} , {R}_{i}^{max} , {\tilde{R}}_{i} \} \qquad ( Equation 28 )$$

where the function median{a, b, c} return the median value among a, b and c. Rᵢ^{max} is the maximum allocated bits for the i^{th} frame to avoid the decoder buffer underflow, and Rᵢ^{min} is the minimum allocated bits for the i^{th} frame to avoid the decoder buffer overflow.

The parameters of the IFDM presented herein in Equation 11 and the R-D model presented in Equation 15 are updated with the coded information during encoding. To elaborate, let \hat{R}ₜ, \hat{D}ₜ, \hat{σ}ₜ² and \hat{Q}ₜ denote the actual generated bits, the distortion, the variance of DCT coefficients and the employed QStep of the t^{th} frame. Then, after the n^{th} frame is encoded, α, β and γ are updated per Equation 30:

Ω=(X^{T}X)⁻¹X^{T}y (Equation 30)

where Ω=(αβγ)^{T}, y=(σₙ²σₙ₋₁² . . . σ_{n-H+1}²)^{T} and X is a Hx3 matrix defined as:

$$X = ( \begin{matrix}{\hat{D}}_{n - 1} & {\tilde{σ}}_{n}^{2} & {\hat{Q}}_{n} \\ {\hat{D}}_{n - 2} & {\tilde{σ}}_{n - 1}^{2} & {\hat{Q}}_{n - 1} \\ … & … & … \\ … & … & … \\ {\hat{D}}_{n - H} & {\tilde{σ}}_{n - H + 1}^{2} & {\hat{Q}}_{n - H + 1}\end{matrix} ) \qquad ( Equation 31 )$$

where H is the number of previous frames used for the parameter update. In an exemplary embodiment, H is set to be 12.

In addition, a₁ and b₁ in the R-D model Equation 15 are updated as

$$\begin{matrix}{a}_{1} = \frac{H {\sum }_{t = n - H}^{n} {\hat{R}}_{t} {B}_{t} - {\sum }_{t = n - H + 1}^{n} {\hat{R}}_{t} {\sum }_{t = n - H + 1}^{n} {B}_{t}}{H {\sum }_{t = n - H + 1}^{n} {{B}_{t}^{2} ( {\sum }_{t = n - H + 1}^{n} {B}_{t} )}^{2}} & ( Equation 32 ) \\ {b}_{1} = \frac{{\sum }_{t = n - H + 1}^{n} {\hat{R}}_{t} - {a}_{1} {\sum }_{t = n - H + 1}^{n} {B}_{t}}{H} \\ where \\ {B}_{t} = log \frac{{\hat{σ}}_{t}^{2}}{{\hat{D}}_{t}} . & ( Equation 33 )\end{matrix}$$

Different from the parameter updating processes presented in Equations 11 and 15, the parameters in Equation 13 can be obtained by off-line training. Their values are stored in the look-up table which is shown in Table 4. In Table 4, the parameter values are associated with the average frame gradient G.

TABLE 4
Look-up table for the parameters in Equation 12

| | | | |
|---|---|---|---|
| 15 ≦ G < 20 | 0.859 | 4.330 | 0.010 |
| 20 ≦ G < 25 | 0.859 | 5.691 | 0.011 |
| 25 ≦ G < 30 | 0.865 | 7.220 | 0.015 |
| 30 ≦ G < 35 | 0.481 | 3.324 | 0.037 |
| 35 ≦ G | 1.053 | 7.749 | 0.017 |

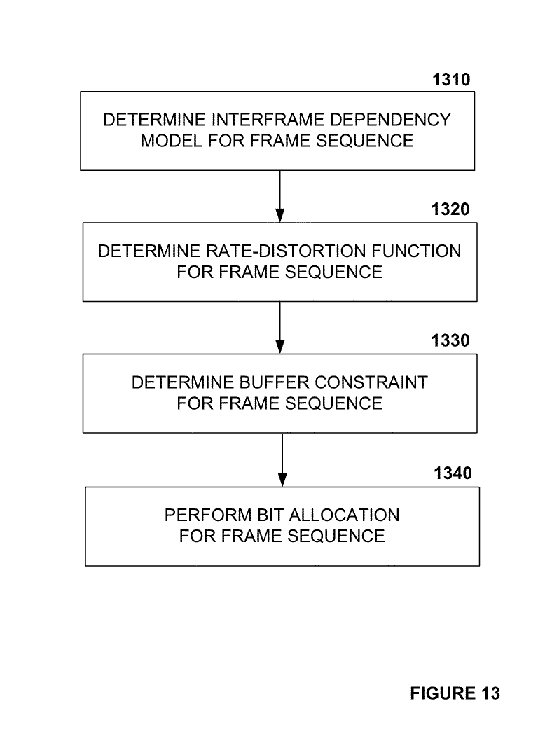

Turning to FIG. 13, is a flow diagram illustrating an exemplary, non-limiting embodiment to maximize a level of compression of data to facilitate improved storage and transmission of digital format video while minimizing distortion. Utilizing the IFDM-DBA as presented herein, bits can be efficiently allocated to frames based on coding dependency between a first frame and a subsequent frame.

At 1310 an interframe dependency model is determined for a frame sequence (e.g., by processor 280). As previously described, particularly with reference to Equation 11, a predictive technique is utilized to determine dependency between at least two frames in a frame sequence. The dependency can facilitate coding dependency for both skipped MBs and non-skipped MBs.

At 1320 a framewise rate-distortion (R-D) function for the sequence of frames is utilized. As previously presented, particularly with reference to Equations 14 and 15, selection of the particular R-D function to apply can be based, in part, on a requirement to model header bits, accuracy of fitting performance, and required estimation of variance of DCT coefficients of the intra-coded frames.

At 1330 a buffer constraint is determined for the sequence of frames. As mentioned previously, the buffer occupancy of a buffer (e.g., memory buffer components 290 or 1150) during decoding should be less than the buffer capacity, as shown in Equation 17.

At 1340, a bit allocation operation is performed utilizing the previously presented frame-level dependent bit allocation (IFDM-DBA) approach (e.g., per Equations 28 and 29). A group of pictures comprises a plurality of frames, where the first frame is encoded as an intra-coded frame and the subsequent j=2, . . . , N frames are encoded as inter-coded frames. Rate R is determined in accordance with [R₁, R₂, . . . R_{N}], with corresponding distortion D=[D₁, D₂, . . . D_{N}].

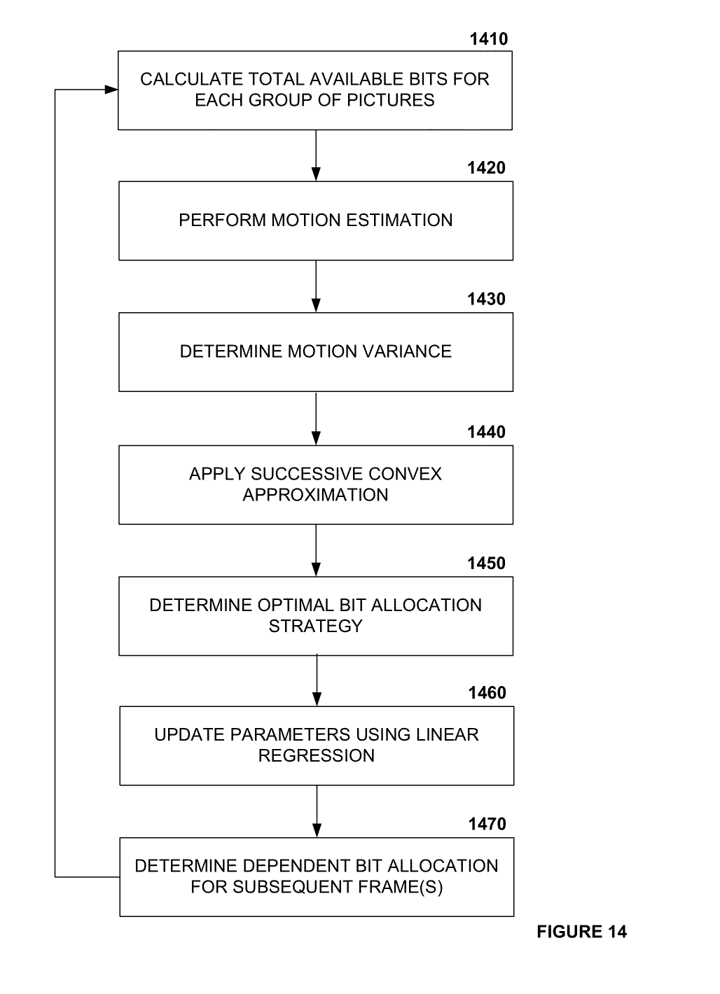

FIG. 14, illustrates a flow diagram of an exemplary, non-limiting embodiment to maximize a level of compression of data to facilitate improved storage and transmission of digital format video while minimizing distortion. Utilizing the IFDM-DBA as presented herein, bits can be efficiently allocated to frames based on coding dependency between a first frame and a subsequent frame.

At 1410, for each GOP the total available bits for coding the frames comprising the GOP are calculated (e.g., by processor 280), per Equation 20, where the total bit budget R_{GOP} for N frames is a function of the average rate R plus any bits remaining from the previous GOP.

At 1420, motion estimation is performed (e.g., by processor 280) on frames i=2, . . . , N of the original video sequence. Any motion estimation can be utilized as applicable to the various embodiments presented herein, for example, Predictive Motion Vector Field Adaptive Search Technique (PMVFAST). Further, any suitable block size (e.g., macroblock size) can be utilized for motion estimation. In an embodiment, a block size of 16×16 is utilized. Further, in another embodiment, any suitable technique can be applied during motion estimation, e.g., only integer-pixel position is checked during motion estimation. Thus the additional computational complexity introduced by motion estimation is greatly reduced.

At 1430, based on the motion estimation, a value for \tilde{σ}ᵢ², as a variance of the residue (per Equation 11) can be obtained (e.g., by processor 280). Further, by approximating quantization stepsize Qᵢ with the average quantization stepsize in the previous GOP, Diffᵢ can be calculated according to Equation 23.

At 1440, based on knowledge of residue variance, quantization stepsize, etc., successive convex approximation is performed (e.g., by processor 280) where a plurality of iterations are performed with each iteration utilizing convex functions to enable determination of compression distortion of a given frame (as shown in FIG. 12). As previously discussed, factors relating to compression distortion, per Equation 24, facilitates determination of compression distortion for an i^{th} frame, per Equation 27. Any suitable application can be utilized, such as MATLAB CVX.

At 1450, based on the iterative approximation(s) the optimal bit allocation strategy (R₁^{*}, R₂^{*}, . . . , R_{N}^{*}) can be derived (e.g., by processor 280). The final bits allocated to the each frame can be adjusted in accordance with Equations 28 and 29, facilitating fulfillment of the total bit budget (e.g., in accord with the buffer constraints of memory 290 or 1150).

At 1460, after each frame in a GOP is encoded the parameters comprising the IFDM and the framewise R-D models, as relating to Equations 11, 12, and 14, can be updated (e.g., by processor 280). Updating of the parameters can be via any suitable method, e.g., linear regression. During encoding, the parameters presented regarding the IFDM in Equation 11 and the R-D model in Equation 15 can be updated with the coded information according to Equations 30-33.

At 1470, with the various models updated, e.g., the framewise R-D model and IFDM, dependent bit allocation can be performed (e.g., by processor 280) on subsequent frames in the GOP, with the flow returning to 1410.

### IFDM-DBA Experimental Results

To evaluate the performance of the various embodiments relating to the IFDM-DBA presented herein, H.264 reference software JM 16.0.8 video sequences listed in Table 5 are selected as the test sequences.

TABLE 5
Test Sequences Used In IFDM Determination

| Sequence | Resolution | Frame Rate | Total Frames |
|---|---|---|---|
| Akiyo | 352x288 | 30 | 300 |
| Coastguard | 352x288 | 30 | 300 |
| Foreman | 352x288 | 30 | 300 |
| Mobile | 352x288 | 30 | 300 |
| City | 1280x720 | 30 | 300 |
| Shuttlestart | 1280x720 | 30 | 300 |
| Cactus | 1920x1080 | 30 | 300 |
| Traffic | 1920x1080 | 30 | 300 |

Note that both standard-definition (SD) and high-definition (HD) video sequences are included. Moreover, the selected video sequences contain quite different video characteristics including slow and fast motions, smooth and complex sceneries. The GOP length is set to be 30, and the framerate is 30 frames per second. Context-adaptive binary arithmetic coding (CABAC) is utilized for entropy coding, and the maximum search range for ME is ±32. RDO is enabled with high complexity mode, while the buffer size is chosen to be the size of the target bitrate, and the initial buffer fullness is the half of the buffer size. For comparison, the quadratic R-D model of the JM reference software is utilized, however, it should be noted that other more sophisticated R-Q models and more advanced QP selection methods can also be utilized.

First, the estimation accuracy of IFDM is evaluated. For each video sequence, it is encoded using JM under a predefined target bitrate. Then, the actual variance and the estimated variance using IFDM of the DCT coefficients are compared. To have a quantitative measure, the estimation error IFDMe is, per Equation 34:

$${IFDM}_{e} = \frac{1}{N} {\sum }_{i = 1}^{N} \frac{\vert {σ}_{i , est}^{2} - {σ}_{i , act}^{2} \vert}{{σ}_{i , act}^{2}} \cdot 100 \% \qquad ( Equation 34 )$$

where N is the total number of frames. σ_{i,est}² and σ_{i,act}² are the estimated variance and the actual variance of the i^{th} frame respectively. The results of IFDMe for the test sequences are summarized in Table 6.

TABLE 6
IFDM Estimation Accuracy

| Sequence | Target Bitrate (kb/s) | IFDMₑ |
|---|---|---|
| Akiyo | 100 | 3.3% |
| Coastguard | 400 | 2.9% |
| Foreman | 400 | 3.1% |
| Mobile | 800 | 3.3% |
| City | 3000 | 3.2% |
| Shuttlestart | 3000 | 2.9% |
| Cactus | 8000 | 2.9% |
| Traffic | 8000 | 2.0% |

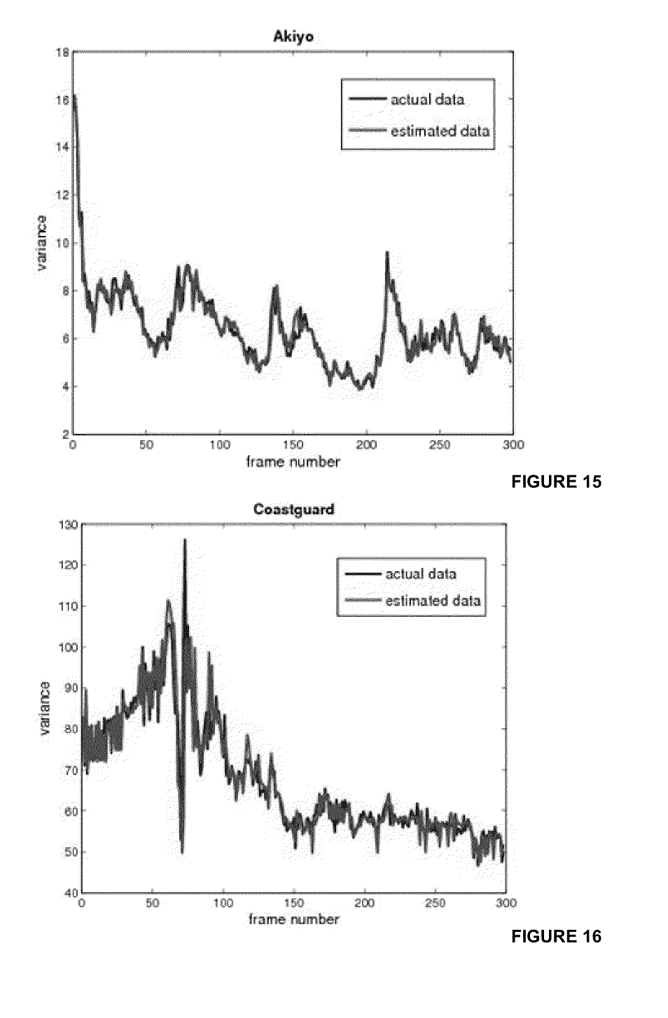

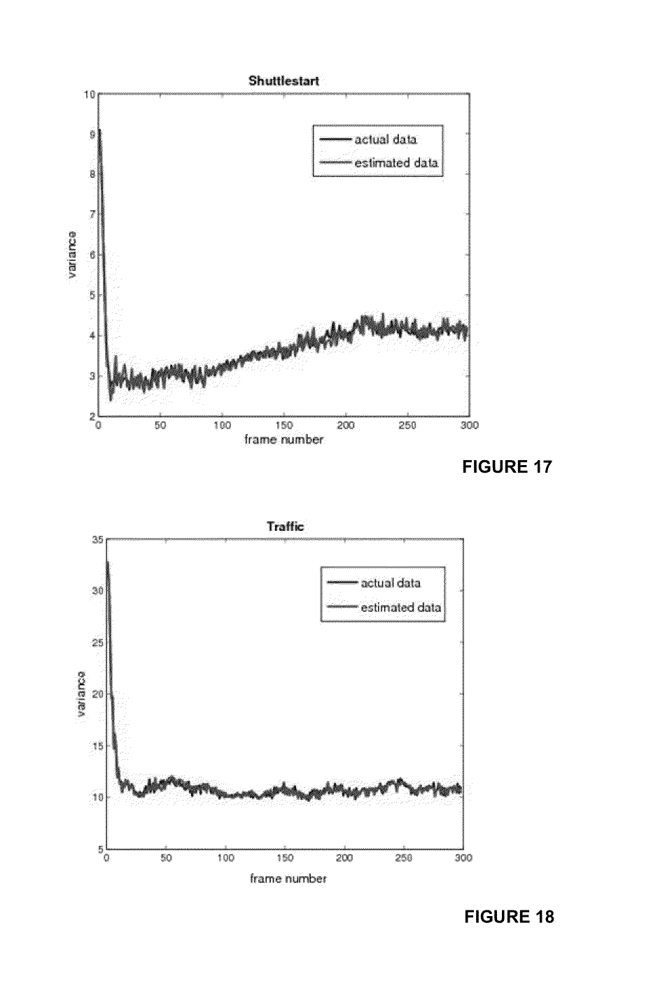

From Table III, it can be seen that the average estimation error of the IFDM is less than 3.0% and the maximum estimation error is less than 3.5%. Besides this overall estimation performance evaluation, the framewise results of the actual and estimated variances of 4 test sequences are shown in FIGS. 15-18. FIGS. 15-18 depict for respective video sequences (Akiyo, Coastguard, Shuttlestart, and Traffic) variance in data (y-axis) versus frame number (x-axis).

The R-D performance of the IFDM-DBA algorithm is compared with two representative bit allocation methods: A is a conventional BA method and B is a conventional frame-level DBA algorithm. The experimental results are summarized in Table 7.

TABLE 7
R-D Performance Comparison with other Bit Allocation Methods

| | Band | | | Prop. | A Over | | B Over | |
|---|---|---|---|---|---|---|---|---|
| | width | PSNR | PSNR | PSNR | BDPSNR | A Over | BDPSNR | B Over |
| Seq. | (kb/s) | (dB) | (dB) | (dB) | (dB) | BDBR | (dB) | BDBR |
| Akiyo | 100 | 39.12 | 39.24 | 39.99 | 0.95 | −23.20% | 0.79 | −19.51% |
| | 150 | 40.44 | 40.61 | 41.39 | | | | |
| | 200 | 41.51 | 41.68 | 42.44 | | | | |
| | 250 | 42.26 | 42.43 | 43.31 | | | | |
| Coast | 300 | 30.21 | 30.27 | 30.42 | 0.31 | −8.10% | 0.23 | −6.21% |
| guard | 400 | 31.17 | 31.26 | 31.49 | | | | |
| | 500 | 31.98 | 32.04 | 32.30 | | | | |
| | 600 | 32.69 | 32.73 | 33.03 | | | | |
| Fore | 300 | 34.39 | 34.49 | 34.90 | 0.51 | −11.62% | 0.43 | −9.92% |
| man | 500 | 36.43 | 36.53 | 36.98 | | | | |
| | 700 | 37.92 | 37.98 | 38.36 | | | | |
| | 900 | 38.97 | 38.98 | 39.38 | | | | |
| Mobile | 500 | 27.81 | 27.87 | 28.21 | 0.36 | −7.80% | 0.34 | −7.41% |
| | 700 | 29.16 | 29.19 | 29.57 | | | | |
| | 900 | 30.35 | 30.35 | 30.63 | | | | |
| | 1100 | 31.35 | 31.35 | 31.60 | | | | |
| City | 2500 | 34.98 | 35.33 | 35.36 | 0.36 | −11.89% | 0.10 | −3.75% |
| | 3000 | 35.53 | 35.81 | 35.90 | | | | |
| | 3500 | 35.97 | 36.18 | 36.31 | | | | |
| | 4000 | 36.36 | 36.48 | 36.67 | | | | |
| Shuttle | 2500 | 43.29 | 43.45 | 43.64 | 0.37 | −18.85% | 0.22 | −12.27% |
| start | 3000 | 43.62 | 43.79 | 44.01 | | | | |
| | 3500 | 43.90 | 44.02 | 44.27 | | | | |
| | 4000 | 44.14 | 44.27 | 44.46 | | | | |
| Cactus | 7000 | 36.28 | 36.43 | 36.53 | 0.24 | −10.62% | 0.14 | −6.90% |
| | 8000 | 36.56 | 36.67 | 36.79 | | | | |
| | 9000 | 36.81 | 36.88 | 37.06 | | | | |
| | 10000 | 37.02 | 37.08 | 37.26 | | | | |
| Traffic | 7000 | 38.12 | 38.14 | 38.78 | 0.65 | −14.27% | 0.60 | −13.02% |
| | 8000 | 38.69 | 38.72 | 39.36 | | | | |
| | 9000 | 39.20 | 39.27 | 39.84 | | | | |
| | 10000 | 39.67 | 39.73 | 40.25 | | | | |
| Avg. | | | | | 0.47 | −13.29% | 0.36 | −9.88% |

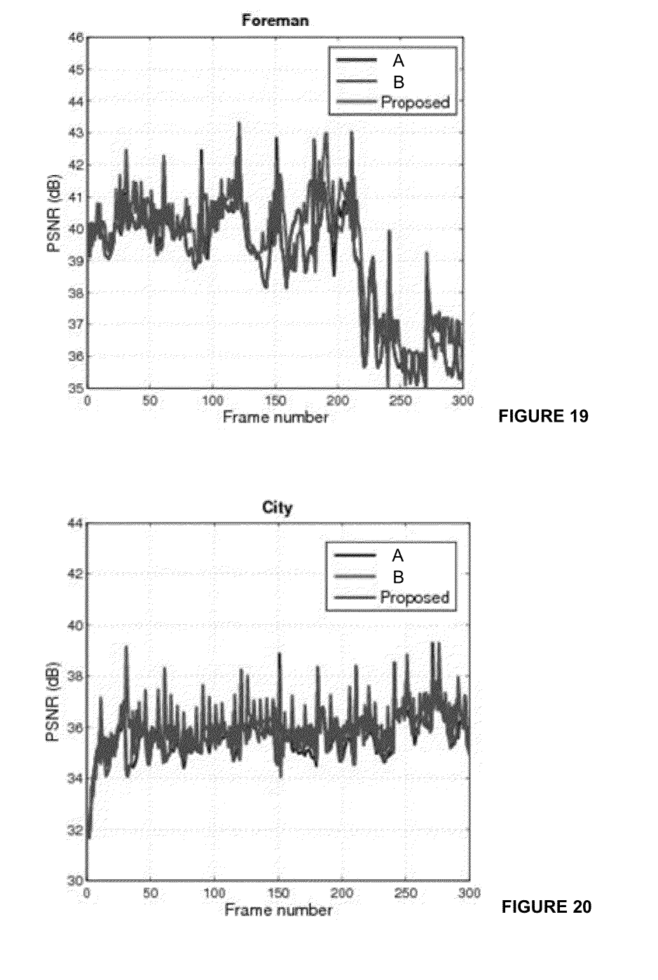

In the experiment, Bjontegaard delta bitrate (BDBR) and Bjontegaard delta peak signal-to-noise ratio (BDPSNR) are deployed to measure the average performance over different bitrate. For BDBR, a negative number in the table indicates a rate reduction achieved by the IFDM-BDA described herein at the same visual quality. As shown in Table 7, on average the IFDM-DBA algorithm has 0.47 and 0.36 dB BDPSNR improvement over A and B respectively. Or equivalently, up to 13.29% and 9.88% bitrate savings are achieved. In addition, for the video sequence in which less motion such as Akiyo, the IFDM-DBA presented herein has 0.95 and 0.79 dB BDPSNR improvement over A and B. Thus, up to 23.20% and 19.51% bitrate can be saved. In addition, to compare the relative behavior of A, B and the subject IFDM-DBA, their respective instantaneous framewise PSNR for two representative sequences (foreman and city) are presented in FIGS. 19 and 20, where PSNR is plotted on the y-axis and Frame Number is plotted on the y-axis.

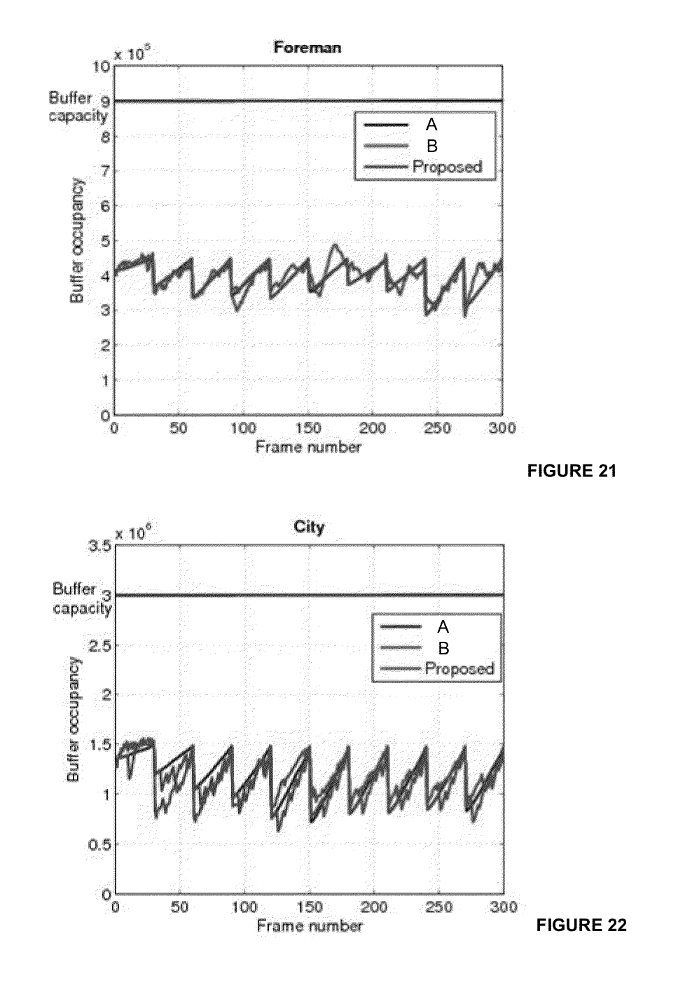

Finally, a comparison is made between the buffer status of the IFDM-DNA with different bit allocation algorithms. As previously presented, during the bit allocation, the buffer fullness needs to be regulated such that buffer overflow or underflow will not occur. The buffer status with different bit allocation algorithms for foreman and city are shown in FIGS. 21 and 22, where Buffer Occupancy (and capacity) is plotted on the y-axis for respective Frame Number(s) plotted on the x-axis. It can be seen that all the 3 methods can always make sure the buffer fullness is at a secure level.

Although currently the dependent bit allocation presented herein is designed for the video coding with IPPP GOP structure, the various embodiments are applicable to other GOP structures, such as IBBP, as well.

### Exemplary Networked and Distributed Environments

One of ordinary skill in the art can appreciate that the various embodiments presented herein for bit allocation applications can be implemented in connection with any computer or other client or server device, which can be deployed as part of a computer network or in a distributed computing environment, and can be connected to any kind of data store. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage. Such a distributed environment can comprise video encoding equipment at a first location and video decoding equipment located at a second location with transmission between the first location and second location being via a network.

Distributed computing provides sharing of computer resources and services by communicative exchange among computing devices and systems. These resources and services include the exchange of information, cache storage and disk storage for objects, such as files, video data, etc. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in facilitating incorporation of a device, having a plurality of network configurations, into any supported network as described for various embodiments of the subject disclosure.

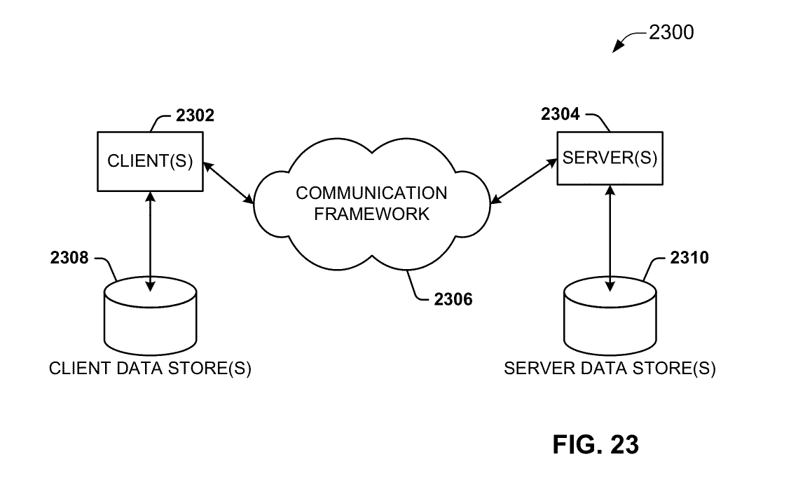

FIG. 23 is a schematic block diagram of a sample-computing environment 2300 with which the disclosed subject matter can interact. The system 2300 includes one or more client(s) 2310. The client(s) 2310 can be hardware and/or software (e.g., threads, processes, computing devices). The system 2300 also includes one or more server(s) 2330. The server(s) 2330 can also be hardware and/or software (e.g., threads, processes, computing devices). The servers 2330 can house threads to perform transformations by employing one or more embodiments as described herein, for example. One possible communication between a client 2310 and a server 2330 can be in the form of a data packet adapted to be transmitted between two or more computer processes. The system 2300 includes a communication framework 2350 that can be employed to facilitate communications between the client(s) 2310 and the server(s) 2330. The client(s) 2310 are operably connected to one or more client data store(s) 2360 that can be employed to store information local to the client(s) 2310. Similarly, the server(s) 2330 are operably connected to one or more server data store(s) 2340 that can be employed to store information local to the servers 2330.

### Exemplary Computing Device

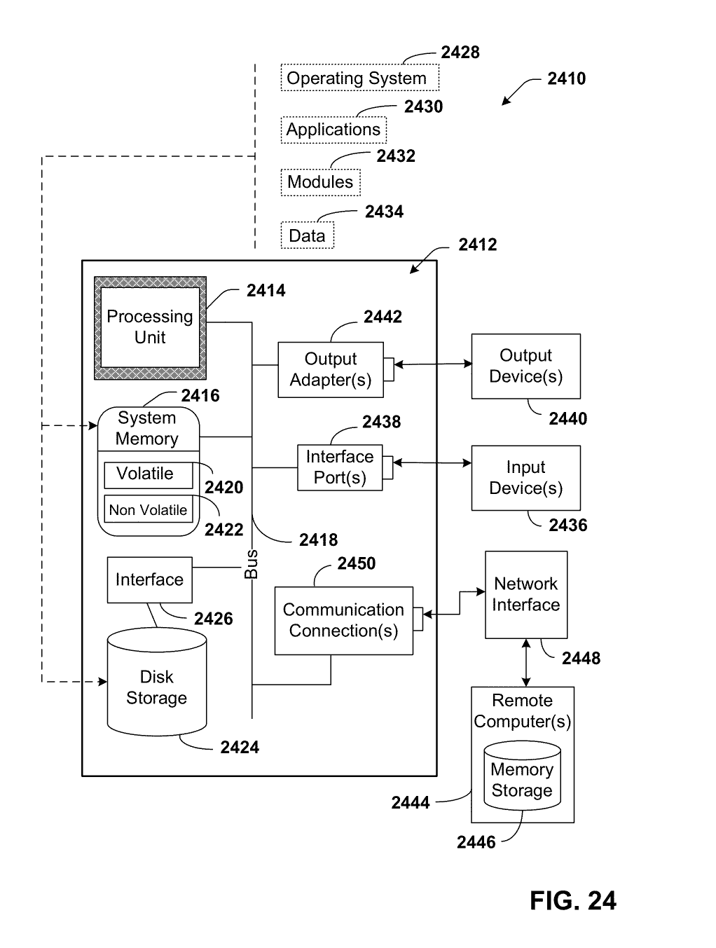

As mentioned, advantageously, the techniques described herein can be applied to any device where it is desirable to compress video data based on IFDM-BDA. It can be understood, therefore, that handheld, portable and other computing devices and computing objects of all kinds are contemplated for use in connection with the various embodiments, i.e., anywhere that where users can access, encode, decode, view, display video data, and associated applications. Accordingly, the below general purpose remote computer described below in FIG. 24 is but one example of a computing device.

Embodiments can partly be implemented via an operating system, for use by a developer of services for a device or object, and/or included within application software that operates to perform one or more functional aspects of the various embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

With reference to FIG. 24, an example environment 2410 for implementing various aspects of the aforementioned subject matter includes a computer 2412. The computer 2412 includes a processing unit 2414, a system memory 2416, and a system bus 2418. The system bus 2418 couples system components including, but not limited to, the system memory 2416 to the processing unit 2414. The processing unit 2414 can be any of various available processors. Dual microprocessors and other multiprocessor architectures also can be employed as the processing unit 2414.

The system bus 2418 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 2416 includes volatile memory 2420 and nonvolatile memory 2422. The basic input/output system (BIOS), containing the basic routines to transfer information between elements within the computer 2412, such as during start-up, is stored in nonvolatile memory 2422. By way of illustration, and not limitation, nonvolatile memory 2422 can include read only memory (ROM), programmable ROM (PROM), electrically programmable ROM (EPROM), electrically erasable PROM (EEPROM), or flash memory. Volatile memory 2420 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 2412 also includes removable/non-removable, volatile/non-volatile computer storage media. FIG. 24 illustrates, for example a disk storage 2424. Disk storage 2424 includes, but is not limited to, devices like a magnetic disk drive, floppy disk drive, tape drive, Jaz drive, Zip drive, LS-100 drive, flash memory card, or memory stick. In addition, disk storage 2424 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 2424 to the system bus 2418, a removable or non-removable interface is typically used such as interface 2426.

It is to be appreciated that FIG. 24 describes software that acts as an intermediary between users and the basic computer resources described in suitable operating environment 2410. Such software includes an operating system 2428. Operating system 2428, which can be stored on disk storage 2424, acts to control and allocate resources of the computer system 2412. System applications 2430 take advantage of the management of resources by operating system 2428 through program modules 2432 and program data 2434 stored either in system memory 2416 or on disk storage 2424. It is to be appreciated that one or more embodiments of the subject disclosure can be implemented with various operating systems or combinations of operating systems.

A user enters commands or information into the computer 2412 through input device(s) 2436. Input devices 2436 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 2414 through the system bus 2418 via interface port(s) 2438. Interface port(s) 2438 include, for example, a serial port, a parallel port, a game port, and a universal serial bus (USB). Output device(s) 2440 use some of the same type of ports as input device(s) 2436. Thus, for example, a USB port may be used to provide input to computer 2412, and to output information from computer 2412 to an output device 2440. Output adapter 2442 is provided to illustrate that there are some output devices 2440 like monitors, speakers, and printers, among other output devices 2440, which require special adapters. The output adapters 2442 include, by way of illustration and not limitation, video and sound cards that provide a means of connection between the output device 2440 and the system bus 2418. It should be noted that other devices and/or systems of devices provide both input and output capabilities such as remote computer(s) 2444.

Computer 2412 can operate in a networked environment using logical connections to one or more remote computers, such as remote computer(s) 2444. The remote computer(s) 2444 can be a personal computer, a server, a router, a network PC, a workstation, a microprocessor based appliance, a peer device or other common network node and the like, and typically includes many or all of the elements described relative to computer 2412. For purposes of brevity, only a memory storage device 2446 is illustrated with remote computer(s) 2444. Remote computer(s) 2444 is logically connected to computer 2412 through a network interface 2448 and then physically connected via communication connection 2450. Network interface 2448 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 2450 refers to the hardware/software employed to connect the network interface 2448 to the bus 2418. While communication connection 2450 is shown for illustrative clarity inside computer 2412, it can also be external to computer 2412. The hardware/software necessary for connection to the network interface 2448 includes, for exemplary purposes only, internal and external technologies such as, modems including regular telephone grade modems, cable modems and DSL modems, ISDN adapters, and Ethernet cards.

As mentioned above, while exemplary embodiments have been described in connection with various computing devices and network architectures, the underlying concepts may be applied to any network system and any computing device or system in which it is desirable to implement a game for real-world application.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

### General Considerations

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

Further, it is possible to infer, e.g., a process of reasoning about or inferring states of the system, environment, and/or user from a set of observations as captured via events and/or data. Inference can be employed to identify a specific context or action, or can generate a probability distribution over states, for example. The inference can be probabilistic, that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

In addition, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Furthermore, the term “set” as employed herein excludes the empty set; e.g., the set with no elements therein. Thus, a “set” in the subject disclosure includes one or more elements or entities. As an illustration, a set of controllers includes one or more controllers; a set of data resources includes one or more data resources; etc. Likewise, the term “group” as utilized herein refers to a collection of one or more entities; e.g., a group of nodes refers to one or more nodes.

As mentioned, the various techniques described herein may be implemented in connection with hardware or software or, where appropriate, with a combination of both. As used in this application, the terms “component,” “system,” “platform,” “layer,” “controller,” “terminal,” “station,” “node,” “interface” are intended to refer to a computer-related entity or an entity related to, or that is part of, an operational apparatus with one or more specific functionalities, wherein such entities can be either hardware, a combination of hardware and software, software, or software in execution. For example, a component can be, but is not limited to being, a process running on a processor, a processor, a hard disk drive, multiple storage drives (of optical or magnetic storage medium) including affixed (e.g., screwed or bolted) or removably affixed solid-state storage drives; an object; an executable; a thread of execution; a computer-executable program, and/or a computer. By way of illustration, both an application running on a server and the server can be a component. One or more components can reside within a process and/or thread of execution, and a component can be localized on one computer and/or distributed between two or more computers. Also, components as described herein can execute from various computer readable storage media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that provides at least in part the functionality of the electronic components. As further yet another example, interface(s) can include I/O components as well as associated processor, application, or Application Programming Interface (API) components. While the foregoing examples are directed to aspects of a component, the exemplified aspects or features also apply to a system, platform, interface, layer, controller, terminal, and the like.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary, non-limiting embodiments presented herein, methodologies that may be implemented in accordance with the exemplary, non-limiting embodiments can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described herein.

Various embodiments described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks [e.g., compact disk (CD), digital versatile disk (DVD) . . . ], smart cards, and flash memory devices (e.g., card, stick, key drive . . . ).

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. A method, comprising:
determining total available bits for a group of pictures;
estimating a difference in motion between a current frame and a preceding frame before the current frame in the group of pictures;
determining a difference in residue between the current frame and the preceding frame;
approximating, based on at least one of the difference in motion or the difference in residue, by successive convex approximation, distortion of the current frame relative to the preceding frame; and
determining a bit allocation for the current frame based on the approximating the at least one of the difference in motion or the difference in residue.

2. The method of claim 1, wherein the total available bits is a function of a number of bits remaining from a previous group of pictures.

3. The method of claim 1, wherein the estimating the difference in motion comprises checking position of a pixel based on integer-pixel format.

4. The method of claim 1, wherein the determining the difference in residue comprises quantizing the difference in residue.

5. The method of claim 1, wherein the successive convex approximation comprises converging the difference in motion or the difference in residue to a single point facilitating solution of a convex approximation.

6. The method of claim 5, wherein the single point satisfies a Karush-Kuhn-Tucker condition enabling solution of a convex optimization problem in the successive convex approximation.

7. The method of claim 1, determining another bit allocation for a subsequent frame after the current frame and the current frame, wherein the determining is based in part on at least one of the estimated difference in motion between the current frame and the preceding frame or the difference in residue between the current frame and the preceding frame.

8. The method of claim 1, wherein the determining of the bit allocation is based on a memory buffer constraint.

9. The method of claim 7, wherein the memory buffer constraint limits a total bit allocation for all frames of the group of pictures to a processing capacity of a memory component associated with the memory buffer constraint.

10. A computer-readable storage medium comprising computer executable instructions that, in response to execution, cause a computing system comprising a processor to perform operations, comprising:
determining total available bits for a group of pictures;
estimating a difference in motion between a current frame and a previous frame preceding the current frame in the group of pictures;
determining a residual difference between the current frame and the previous frame;
approximating, based on at least one of the difference in motion or the residual difference, by successive convex approximation, distortion of the current frame versus the previous frame; and
determining a bit allocation for the current frame based on the approximating.

11. The computer-readable storage medium of claim 10, wherein the total available bits is a function of a number of bits remaining from a previous group of pictures.

12. The computer-readable storage medium of claim 10, wherein the estimating the difference in motion comprises checking an integer-pixel position of a first pixel with reference to an integer-pixel position of a second pixel.

13. The computer-readable storage medium of claim 10, wherein the determining the residual difference comprises applying a quantization to the residual difference.

14. The computer-readable storage medium of claim 10, wherein the operations further comprise determining another bit allocation for a subsequent frame and the current frame, wherein the determining is based at least in part on at least one of the difference in motion between the current frame and the previous frame or the residual difference between the current frame and the previous frame.

15. The computer-readable storage medium of claim 10, wherein the determining of the bit allocation is based at least in part on a memory buffer constraint.

16. The computer-readable storage medium of claim 15, wherein the memory buffer constraint comprises a limit on a total bit allocation for all frames of the group of pictures to a processing capacity of a memory component associated with the memory buffer constraint.

17. A system, comprising:
a memory to store computer-executable instructions; and
a processor, communicatively coupled to the memory, that facilitates execution of the computer-executable instructions to perform operations relating to allocation bits for a plurality of frames comprising a group of pictures, the operations comprising:
determining interframe dependency between a current frame and a previous frame in the plurality of frames;
determining a buffer-constrained frame-level dependent bit allocation; and
applying at least one successive convex approximation to the buffer-constrained frame-level dependent bit allocation facilitating deriving the bit allocation for the current frame.

18. The system of claim 17, wherein the buffer-constrained frame-level dependent bit allocation is constrained by a capacity of a memory buffer component associated with the processor.

19. The system of claim 17, wherein the determining the interframe dependency further comprises determining at least one of variance between discrete cosine transforms or a quantization step size.

20. The system of claim 19, wherein the operations further comprise determining another bit allocation for a subsequent frame, wherein the determining comprises applying, to the subsequent frame, at least one of the variance between discrete cosine transforms for the current frame or the quantization step size for the current frame.
